(19) United States
(12) Patent Application Publication
(10) Pub. No.: US 2025/0220662 A1
(43) Pub. Date: Jul. 3, 2025

(54) LARGE LANGUAGE MODEL (LLM) DRIVEN PROACTIVE SCHEDULING

(71) Applicant: Cisco Technology, Inc., San Jose, CA (US)

(72) Inventors: Pengfei Sun, San Jose, CA (US); Qihong Shao, Clyde Hill, WA (US)

(73) Assignee: Cisco Technology, Inc., San Jose, CA (US)

(21) Appl. No.: 19/005,817

(22) Filed: Dec. 30, 2024

Related U.S. Application Data
(60) Provisional application No. 63/616,545, filed on Dec. 30, 2023.

(51) Int. Cl. H04W 72/12; H04B 7/0413; H04W 24/02; H04W 72/50; H04W 84/12

(52) U.S. Cl. CPC H04W 72/12; H04W 24/02; H04W 72/50; H04B 7/0413; H04W 84/12

(57) ABSTRACT

Large Language Model (LLM) driven proactive scheduling may be provided. First, a proactive feedback module may be used that gathers user requests and device feedback. Next, an instructive interpreter module may be used that receives the user requests and the device feedback and produces instructive prompts based on the user requests and the device feedback. Then a user-reinforced scheduling optimization module may be used that receives responses to the instructive prompts and continuously enhances bandwidth scheduling based on the receives responses.

### RELATED APPLICATION

Under provisions of 35 U.S.C. § 119(e), Applicant claims the benefit of U.S. Provisional Application No. 63/616,545, filed Dec. 30, 2023, which is incorporated herein by reference.

### TECHNICAL FIELD

The present disclosure relates generally to providing Large Language Model (LLM) driven proactive scheduling.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing Large Language Model (LLM) driven proactive scheduling;

FIG. 2 illustrates the inconsistency between passive bandwidth allocation and active bandwidth demanding;

FIG. 3 is a flow chart of a method for providing LLM driven proactive scheduling;

FIG. 4 illustrates a Large Language model-driven Proactive Scheduling system (LPS);

FIG. 5 illustrates passive and active feedback/requests from users for the proactive scheduling module;

FIG. 6 illustrates a pipeline for translating users' different requests;

FIG. 7 illustrates the instructive interpreter module;

FIG. 8 illustrates a sample instructive interpreter module;

FIGS. 9A and 9B illustrate LLM-as-Optimizer for proactive bandwidth scheduling; and

FIG. 10 is a block diagram of a computing device.

### DETAILED DESCRIPTION

### Overview

Large Language Model (LLM) driven proactive scheduling may be provided. First, a proactive feedback module may be used that gathers user requests and device feedback. Next, an instructive interpreter module may be used that receives the user requests and the device feedback and produces instructive prompts based on the user requests and the device feedback. Then a user-reinforced scheduling optimization module may be used that receives responses to the instructive prompts and continuously enhances bandwidth scheduling based on the receives responses.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Multi-user Multi-Input-Multi-Output (MU-MIMO) technology may be pivotal in the context of next-generation wireless communication. More precisely, the scheduling of users/devices in MU-MIMO may not only impact the overall throughput performance, but may also play a significant role in ensuring fairness among users. In conventional processes, efforts to optimize bandwidth allocation among users may primarily hinge on feedback from their respective devices. While established criteria like Channel State Index and user Signal-to-Noise Ratios (SNIRs) may be effectively employed to maximize throughput objectively, conventional processes may exhibit a deficiency in considering user intent. This oversight may create a gap between passive bandwidth distribution and the diverse priorities of users.

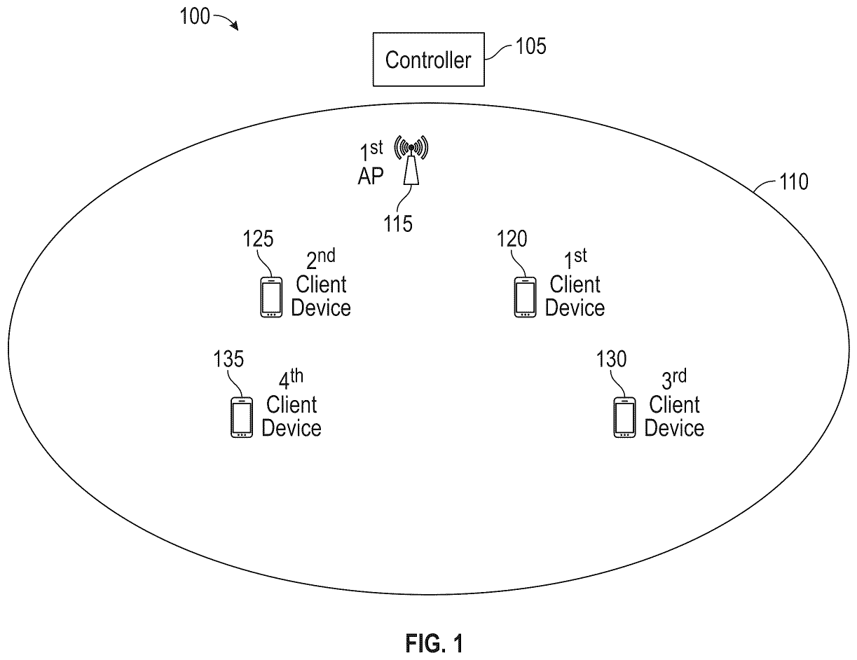

FIG. 1 shows an operating environment 100 for providing Large Language Model (LLM) driven proactive scheduling. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may include, but are not limited to, a first AP 115 in addition to other APs. The plurality of APs may provide wireless network access to a plurality of client devices as they move within coverage environment 110.

The plurality of client devices may comprise, but are not limited to, a first client device 120, a second client device 125, a third client device 130, and a fourth client device 135. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. The plurality of client devices may also be Multi-user MIMO (MU-MIMO), which may comprise a set of technologies for multipath wireless communication, in which multiple users or terminals, each radioing over one or more antennas, communicate with one another. Each of the plurality of APs and the plurality of client devices may be compatible with specification standards such as, but not limited to, the Institute of Electrical and Electronics Engineers (IEEE) 802.11ax/be specification standard for example.

Controller 105 may comprise a Wireless Local Area Network Controller (WLC) and may provision and control coverage environment 110 (e.g., a WLAN). Controller 105 may allow first client device 120, second client device 125, third client device 130, and fourth client device 135 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide LLM driven proactive scheduling.

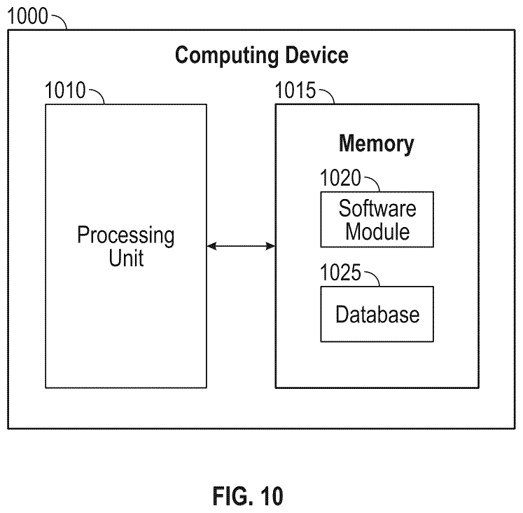

The elements described above of operating environment 100 (e.g., controller 105, first AP 115, first client device 120, second client device 125, third client device 130, or fourth client device 135) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 10, the elements of operating environment 100 may be practiced in a computing device 1000.

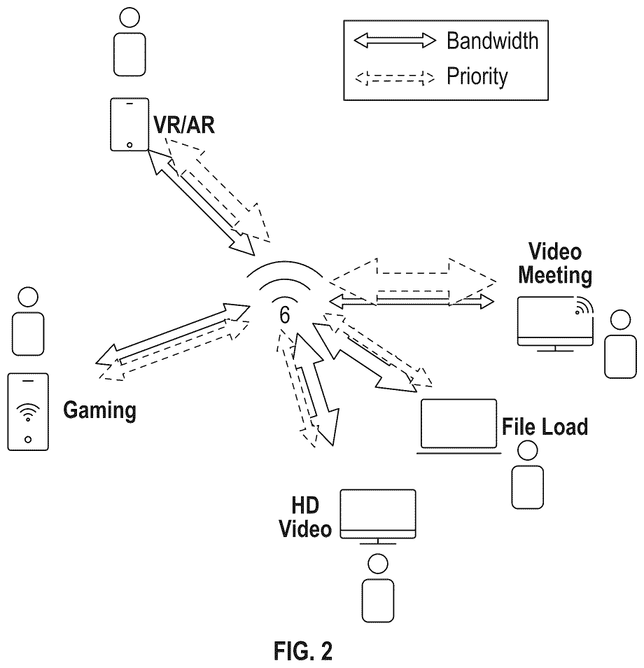

FIG. 2 illustrates the inconsistency between passive bandwidth allocation and active bandwidth demanding. The width of the flow may be proportional to the bandwidth. As illustrated by FIG. 2, dynamic bandwidth distribution may effectively capture the packet requirements of individual devices. However, it may fall short in adequately addressing each wireless user's priority in relation to their ongoing tasks. To bridge the divide between usage-only feedback and user intentions (e.g., urgent task), the current MU-MIMO user grouping framework faces several challenges including passive feedback-based dynamic bandwidth allocations. For example, conventional Wi-Fi bandwidth allocation in MU-MIMO may rely solely on feedback from client devices. The conventional process may lack the capacity to engage with users and respond to their specific bandwidth allocation requests.

Other challenges may include an absence of a mechanisms to incorporate user-intention. With this challenge, within the existing user grouping framework, conventional optimization may not add users' subjective preferences as an instantaneous response. Accordingly, there may be a need for an intelligent agent capable of incorporating feedback from each user, not just their devices. Another challenge may comprise high overhead for user grouping/bandwidth optimization. With this challenge, in Wi-Fi application, the high overhead with respect to feedback from client devices may directly constraint the overall optimization on bandwidth allocation because of no dedicated control channel. The additional users' requests may further deteriorate the situation in Wi-Fi MU-MIMO.

Embodiments of the disclosure may harness a Large Language model-driven Proactive Scheduling system (LPS) as an intelligent agent (e.g., host on separated hardware or a centralized IoT hub). This agent may comprehensively consider both passive device feedback and user intentions, resulting in optimal bandwidth distribution scheduling for access points.

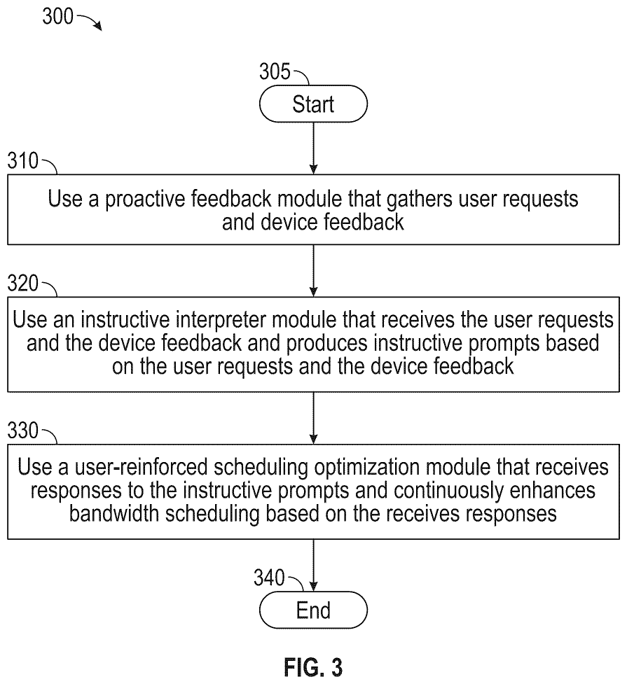

FIG. 3 is a flow chart setting forth the general stages involved in a method 300 consistent with embodiments of the disclosure for providing LLM driven proactive scheduling. Method 300 may be implemented using a computing device 1000 as described in more detail below with respect to FIG. 10. Computing device 1000 may be embodied by first AP 115 or controller 105 for example. Ways to implement the stages of method 300 will be described in greater detail below.

### Architecture

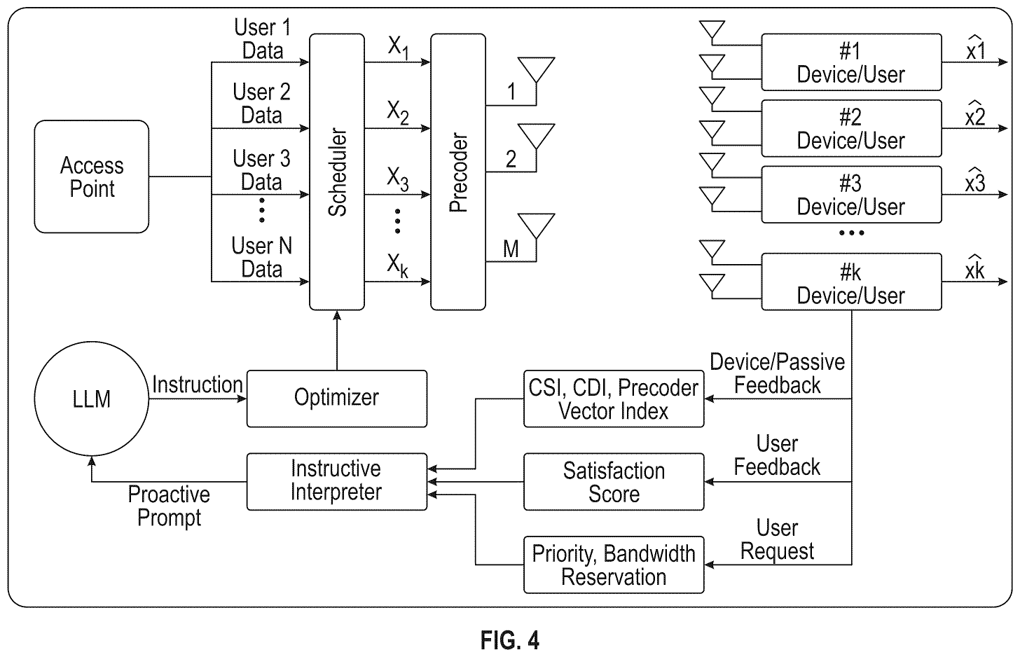

FIG. 4 illustrates a Large Language model-driven Proactive Scheduling system (LPS). This LPS system may encompass three specific features: i) a Proactive Feedback Module; ii) an Instructive Interpreter Module; and iii) a User-Reinforced Scheduling Optimization Module. With the Proactive Feedback Module, initially, the system may proactively gather channel state information and users' bandwidth requests. With the Instructive Interpreter, the combined feedback may be channeled into an instructive prompt engine, denoted as the instructive interpreter module. This engine may be responsible for producing instructive prompts that consider both devices' traffic feedback and users' subjective requests. The User-Reinforced Scheduling optimization Module may involve the LLM acting as an optimizer to continuously enhance the bandwidth scheduling. To achieve this, the user-reinforced scoring system may reward the LLM's outcomes (i.e., the re-distributed bandwidth across users), and the satisfaction scores based on the updated device bandwidth are consumed as feedback by the instructive interpreter to update prompts.

### Proactive Feedback Module

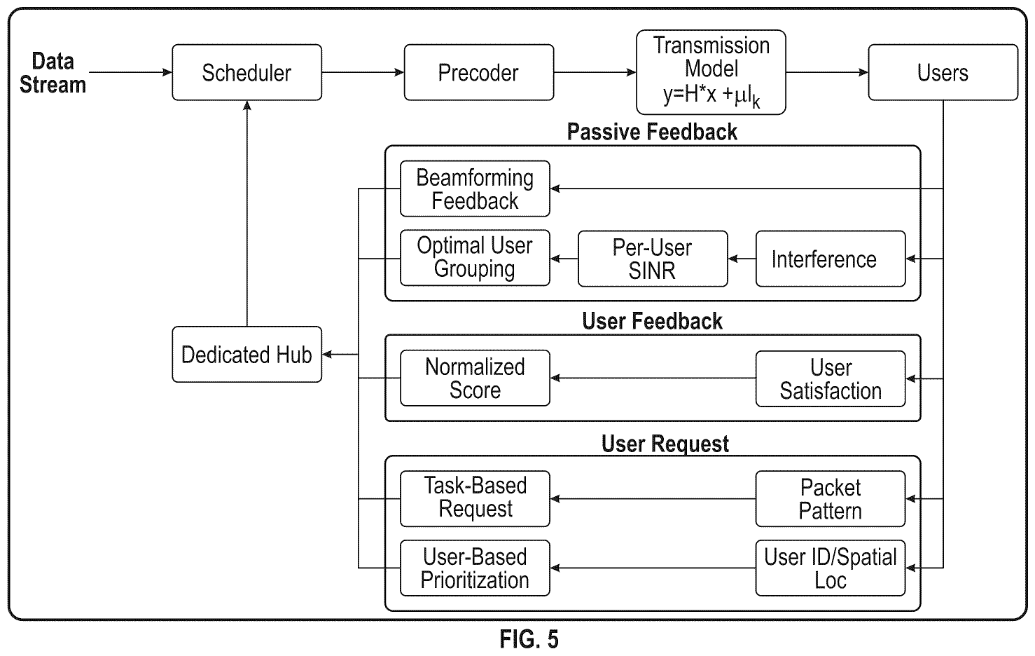

Method 300 may begin at starting block 305 and proceed to stage 310 where computing device 1000 may use a proactive feedback module that gathers user requests and device feedback. FIG. 5 illustrates passive and active feedback/requests from users for the proactive scheduling module. For example, within the proactive feedback module, embodiments of the disclosure may gather feedback related to both device traffic and user requests. As shown in FIG. 5, this amalgam of passive and proactive feedback may be transmitted to a dedicated hub where the LLM may reside. The advantages of this setup may be: i) efficient channel state index processing; and ii) integration with an intelligent Internet-of-Things (IoT) hub. With efficient channel state index processing, a separate hub may play a role in processing the channel state index data, effectively circumventing the resource exhaustion issues associated with conventional high overhead methods. With integration with intelligent IoT hub, this separate hub, potentially serving as an intelligent IoT hub, may facilitate the seamless integration of Wi-Fi access points into a group of IoT devices. This integration may offer enhanced functionality and connectivity within the broader IoT ecosystem.

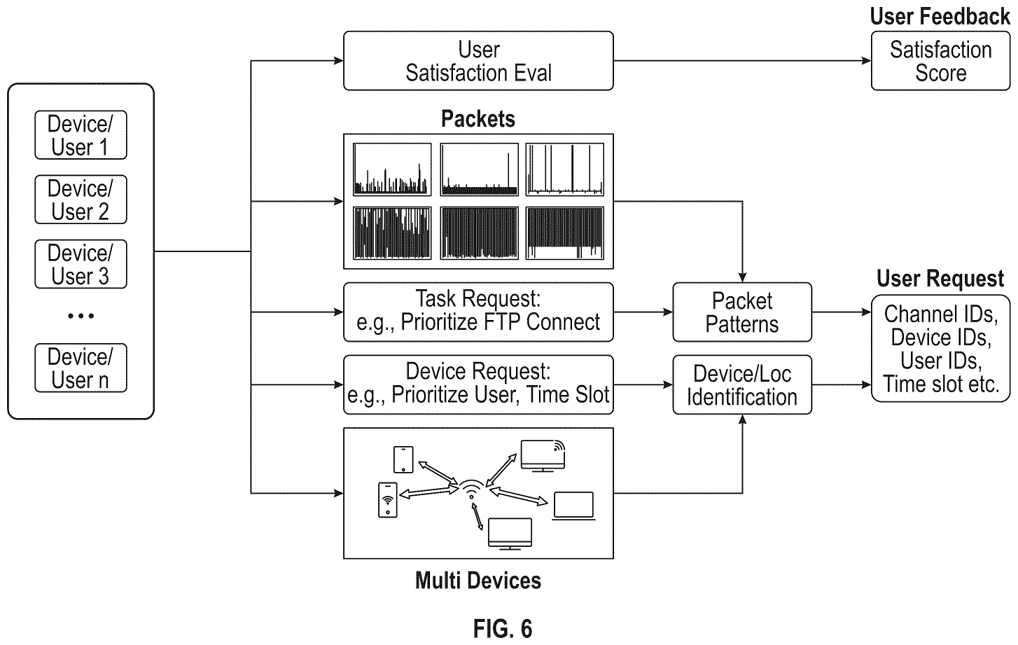

FIG. 6 illustrates a pipeline for translating users' different requests (e.g., task-depended bandwidth request, device-depended bandwidth request). As shown in FIG. 6, the proactive feedback from users may be classified as two types: i) user requests; and ii) user feedback. User requests may include the task-priority based request and the device-priority based request. In the task-priority based request, the feedback module may recognize the traffic patterns and accordingly match the patterns with the specific tasks, such as file download, Voice over Internet Protocol (VOIP), or video streaming, etc. Therefore, it may assign the priorities to each traffic stream based on the request. In device-priority based request, the feedback module may assign the bandwidth according to the users' priorities. User feedback regards the satisfaction on allocated bandwidth. The normalized satisfaction score may be used for reinforced prompt generation in the next round optimization.

### Instructive Interpreter Module

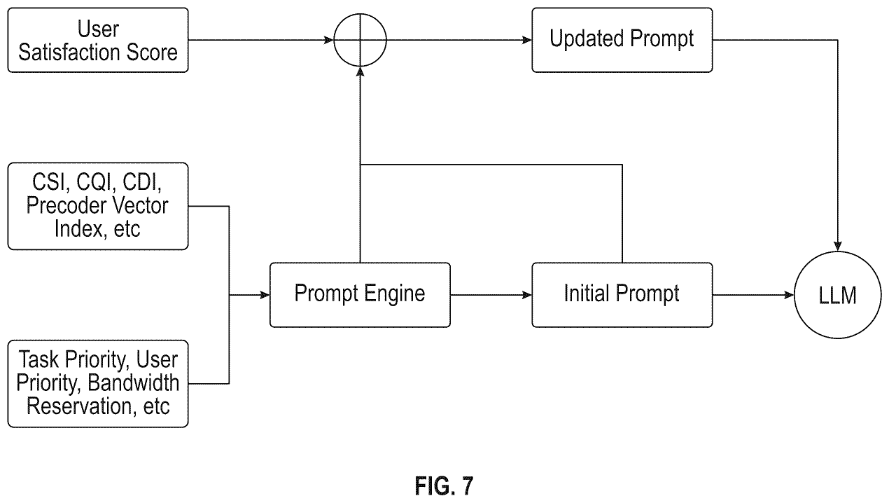

From stage 310, where computing device 1000 uses the proactive feedback module that gathers user requests and device feedback, method 300 may advance to stage 320 where computing device 1000 may use an instructive interpreter module that receives the user requests and the device feedback and produces instructive prompts based on the user requests and the device feedback. FIG. 7 illustrates the instructive interpreter module. For example, in the instructive interpreter module, as shown in FIG. 7, embodiments of the disclosure may leverage the latest prompt engineering technics to generate highly guidable instruction that embeds passive feedback from device traffic usage, active feedback from user requests, and the reinforced user satisfaction feedback.

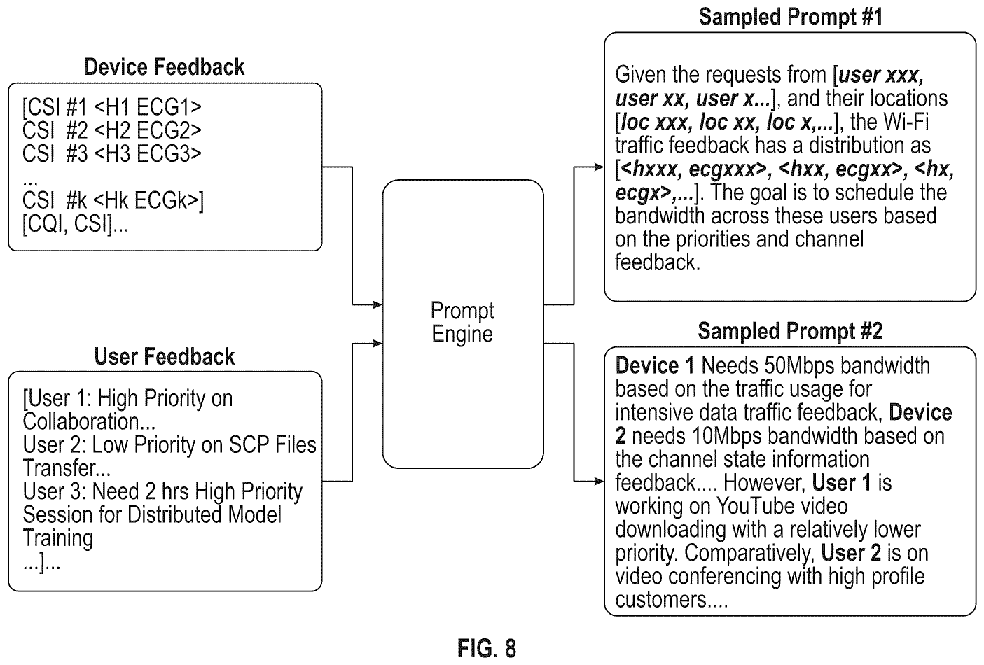

A detailed sample is illustrated in FIG. 8. In this selected sample, the device feedback may include the channel state index and the effective channel gain. Comparatively, in user feedback, the priority levels regarding the user request have been provided. The prompt engine may consume those details to generate effective prompt used for LLM scheduling.

### User-Reinforced Scheduling Optimization Module

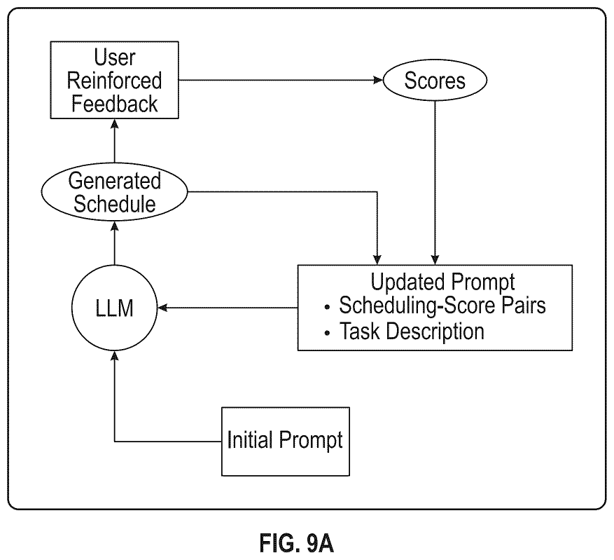

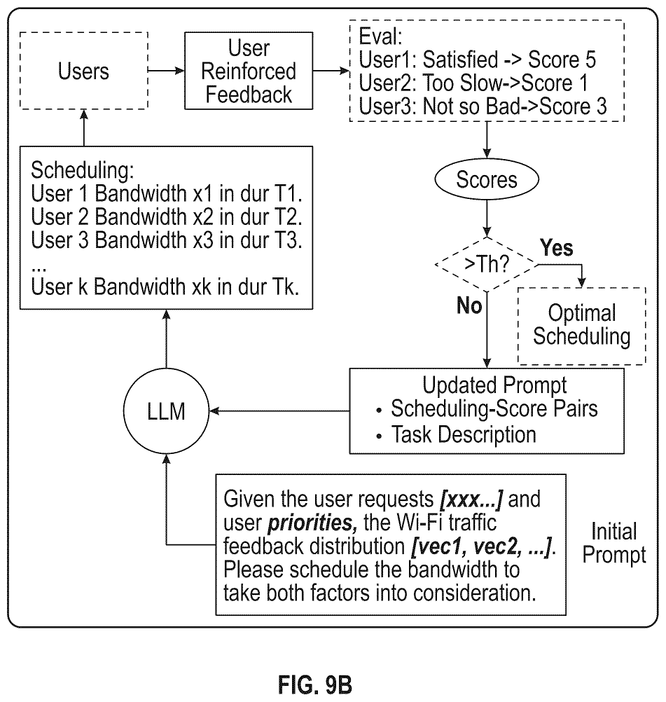

Once computing device 1000 uses the instructive interpreter module that receives the user requests and the device feedback and produces instructive prompts based on the user requests and the device feedback in stage 320, method 300 may continue to stage 330 where computing device 1000 may use a user-reinforced scheduling optimization module that receives responses to the instructive prompts and continuously enhances bandwidth scheduling based on the receives responses. FIGS. 9A and 9B illustrate LLM-as-Optimizer for proactive bandwidth scheduling. For example, with the user-reinforced scheduling optimization module, as shown in FIG. 9A, the LLMs may generate a bandwidth schedule based on the initial prompt from instructive interpreter module. After deploying the generated schedule, users may response to the new bandwidth allocation and provide feedback to score the bandwidth schedule. As shown in FIG. 9B, the LLM may be used as an optimizer, and a reinforced optimization strategy may be employed to continuously improve the bandwidth allocation. For example, if the users provide a low score on the latest scheduling plan, an updated prompt that combines original task description and the scheduler-score pair may be applied for the next round solution generation. In this way, an on-line reinforced bandwidth scheduling according to users' satisfaction may proactively optimize the traffic distribution.

Accordingly, with embodiments of the disclosure, a reverse prompt generation module may be provided to train a unified prompt engine. In addition, the unified prompt engine may be a multi-task actor that may allow the generation of different domain-dependent prompts for incorporation of specialized knowledge. Moreover, customer profiles and asset information may also be utilized to further contextualize the prompt. By using deep customization in the prompt generation, the unified prompt engine may generate specific tailored solutions in network automation. Once computing device 1000 uses the user-reinforced scheduling optimization module that receives responses to the instructive prompts and continuously enhances bandwidth scheduling based on the receives responses in stage 330, method 300 may then end at stage 340.

FIG. 10 shows computing device 1000. As shown in FIG. 10, computing device 1000 may include a processing unit 1010 and a memory unit 1015. Memory unit 1015 may include a software module 1020 and a database 1025. While executing on processing unit 1010, software module 1020 may perform, for example, processes for providing LLM driven proactive scheduling as described above with respect to FIG. 3. Computing device 1000, for example, may provide an operating environment for controller 105, first AP 115, first client device 120, second client device 125, third client device 130, or fourth client device 135. Controller 105, first AP 115, first client device 120, second client device 125, third client device 130, or fourth client device 135 may operate in other environments and are not limited to computing device 1000.

Computing device 1000 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1000 may comprise any computer operating environment, such as hand-held devices, multiprocessor systems, microprocessor-based or programmable sender electronic devices, minicomputers, mainframe computers, and the like. Computing device 1000 may also be practiced in distributed computing environments where tasks are performed by remote processing devices. The aforementioned systems and devices are examples and computing device 1000 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 1000 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
using a proactive feedback module that gathers user requests and device feedback;
using an instructive interpreter module that receives the user requests and the device feedback and produces instructive prompts based on the user requests and the device feedback; and
using a user-reinforced scheduling optimization module that receives responses to the instructive prompts and continuously enhances bandwidth scheduling based on the receives responses.

2. The method of claim 1, wherein the user requests comprise at least one of task prioritization and user satisfaction.

3. The method of claim 1, wherein the device feedback comprises at least one of Signal-to-Interference-Plus-Noise Ratio (SINR), interferences, sounding packets, and link state.

4. The method of claim 1, wherein the bandwidth scheduling is performed for a Multi User-Multiple Input Multiple Output (MU-MIMO) Wi-Fi application.

5. The method of claim 1, wherein the method is based on a Large Language Model (LLM).

6. The method of claim 1, wherein the method is performed in an Access Point (AP).

7. The method of claim 1, wherein the method is performed in a controller.

8. A system comprising:
a memory storage; and
a processing unit, disposed in a computing device and coupled to the memory storage, wherein the processing unit is operative to:
use a proactive feedback module that gathers user requests and device feedback;
use an instructive interpreter module that receives the user requests and the device feedback and produces instructive prompts based on the user requests and the device feedback; and
use a user-reinforced scheduling optimization module that receives responses to the instructive prompts and continuously enhances bandwidth scheduling based on the receives responses.

9. The system of claim 8, wherein the user requests comprise at least one of task prioritization and user satisfaction.

10. The system of claim 8, wherein the device feedback comprises at least one of Signal-to-Interference-Plus-Noise Ratio (SINR), interferences, sounding packets, and link state.

11. The system of claim 8, wherein the bandwidth scheduling is performed for a Multi User-Multiple Input Multiple Output (MU-MIMO) Wi-Fi application.

12. The system of claim 8, wherein the computing device comprises an Access Point (AP).

13. The system of claim 8, wherein the computing device comprises a controller.

14. A non-transitory computer-readable medium that stores a set of instructions which when executed perform a method executed by the set of instructions comprising:
using a proactive feedback module that gathers user requests and device feedback;
using an instructive interpreter module that receives the user requests and the device feedback and produces instructive prompts based on the user requests and the device feedback; and
using a user-reinforced scheduling optimization module that receives responses to the instructive prompts and continuously enhances bandwidth scheduling based on the receives responses.

15. The non-transitory computer-readable medium of claim 14, wherein the user requests comprise at least one of task prioritization and user satisfaction.

16. The non-transitory computer-readable medium of claim 14, wherein the device feedback comprises at least one of Signal-to-Interference-Plus-Noise Ratio (SINR), interferences, sounding packets, and link state.

17. The non-transitory computer-readable medium of claim 14, wherein the bandwidth scheduling is performed for a Multi User-Multiple Input Multiple Output (MU-MIMO) Wi-Fi application.

18. The non-transitory computer-readable medium of claim 14, wherein the method is based on a Large Language Model (LLM).

19. The non-transitory computer-readable medium of claim 14, wherein the method is performed in an Access Point (AP).

20. The non-transitory computer-readable medium of claim 14, wherein the method is performed in a controller.
